(19) United States
(12) Patent Application Publication
(10) Pub. No.: US 2008/0085381 A1
(43) Pub. Date: Apr. 10, 2008

(54) OPTICAL ELEMENT WITH A POLARIZER AND A SUPPORT LAYER

(75) Inventors: Gunnar H. Gunnarsson, Cincinnati, OH (US); David M. Snively, Cincinnati, OH (US); Xuequn Hu, Cincinnati, OH (US); Ying-Yuh Lu, Woodbury, MN (US); Kevin M. Lewandowski, Inver Grove Heights, MN (US); Joseph D. Rule, Cottage Grove, MN (US); Pradnya V. Nagarkar, Weston, MA (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/866,616

(22) Filed: Oct. 3, 2007

Related U.S. Application Data
(60) Provisional application No. 60/828,486, filed on Oct. 6, 2006.

(51) Int. Cl. C09K 19/02; B05D 3/02; B32B 17/10; B32B 27/30; B32B 3/02; C08F 120/18; C08F 2/46; C08L 33/04

(52) U.S. Cl. 428/1.31; 427/372.2; 428/220; 428/332; 428/442; 428/522; 428/76; 522/1; 525/222; 526/329.7

(57) ABSTRACT

An optical element with a polarizer and a support layer is disclosed herein. The polarizer comprises an intrinsic polarizer and the support layer comprises the reaction product of: (a) from 50 to 99 parts by weight of a (meth)acryloyl oligomer having a plurality of pendant, free radically polymerizable functional groups and a Tg of greater than or equal to 20° C., (b) from 1 to 50 parts by weight of a free-radically polymerizable crosslinking agent and/or diluent monomer, and (c) from 0.001 to 5 parts by weight of an initiator. A method of forming the optical element is also disclosed herein. The optical element may be used in optical devices such as projector systems.

### CROSS REFERENCE TO RELATED APPLICATION

This application claims the benefit of U.S. Provisional Patent Application No. 60/828,486, filed Oct. 6, 2006, the disclosure of which is incorporated herein by reference in its entirety.

### TECHNICAL FIELD

In general, the present disclosure is directed to an optical element including a polarizer and a support layer with physical and optical properties that are compatible with the physical and optical properties of the polarizer. The optical element may be used in a wide variety of electronic display devices, and is particularly well suited for use in projection systems.

### BACKGROUND

Liquid crystal displays (LCDs) are widely used in electronic display devices such as, for example, computer displays, televisions and monitors, projection systems and digital clocks and watches. A typical polarizer used for LCD applications includes a polarizing material such as, for example, a polymeric film, which is sandwiched between adjacent layers of a transparent protective material that provide support and isolate the polarizer from the environment. An adhesive, particularly a pressure sensitive adhesive, may be used to bond the protective material to the polarizer.

FIG. 1 illustrates a typical construction of a known optical element 10, which may be used as part of an optical system such as an LCD projector. The optical element 10 includes a polarizer construction 12 which is attached to a substrate 14. The substrate provides support to the optical element and may be made of a wide variety of materials such as, for example, cellulose triacetate (TAC) or optically clear glass. The polarizer construction 12 includes polarizer 22 which is bonded to transparent protective layers 18 and 26 with polyvinyl alcohol doping. Suitable materials for the transparent protective layers include cellulose esters such as nitrocellulose, cellulose acetate, cellulose triacetate (TAC), cellulose acetate butyrate, polyesters such as polyethylene terephthalate, or polycarbonates; TAC is often used. On one of the protective layers is disposed an adhesive layer 16, typically comprising a pressure sensitive adhesive (PSA), which is used to adhere the protective layer to the substrate 14. On the other protective layer is a hardcoat layer 28 and an antireflective coating 30. The optical element 10 may be laminated to another optical element for use in an LCD device. Examples of other optical elements include reflectors, transflectors, retardation plates, viewing angle compensation films, and brightness enhancement films. Again, pressure sensitive or other optical adhesives may be used to bond the optical members.

### SUMMARY

An optical element with a polarizer and a support layer is disclosed herein. In one aspect, the polarizer comprises an intrinsic polarizer and the support layer comprises the reaction product of: (a) from 50 to 99 parts by weight of a (meth)acryloyl oligomer having a plurality of pendant, free radically polymerizable functional groups and a Tg of greater than or equal to 20° C., (b) from 1 to 50 parts by weight of a free-radically polymerizable crosslinking agent and/or diluent monomer, and (c) from 0.001 to 5 parts by weight of an initiator. In one embodiment, the polarizer comprises a KE-type polarizer or a K-type polarizer. In another embodiment, the (meth)acryloyl oligomer comprises the reaction product of: (a) from 50 to 99 parts by weight of (meth)acrylate ester monomer units homopolymerizable to a polymer having a Tg of greater than or equal to 20° C., (b) from 1 to 50 parts by weight of monomer units having a pendent, free-radically polymerizable functional group, and (c) less than 40 parts by weight of monomer units homopolymerizable to a polymer having a glass transition temperature of less than 20° C., based on 100 parts by weight of a) and b). In other embodiments, the polarizer can be encapsulated in the support layer, or a second support layer can be disposed adjacent the polarizer opposite the other support layer. One or more substrates can also be included in the optical element.

In another aspect, disclosed herein is an optical element comprising: an intrinsic polarizer having opposing first and second major surfaces; a first support layer on the first major surface of the intrinsic polarizer, the first support layer having an (absolute) birefringence of less than 1×10⁻⁶, a Tg of greater than 50° C., an index of refraction of from 1.45 to 1.80, and a light transmission of greater than about 85% over the visible spectrum; a first optically clear substrate on the first support layer opposite the intrinsic polarizer; a second support layer on the second major surface of the intrinsic polarizer, the second support layer having a birefringence of less than 1×10⁻⁶, a Tg of greater than 50° C., an index of refraction of from 1.45 to 1.80, and a light transmission of greater than about 85% over the visible spectrum; and a second optically clear substrate on the second support layer opposite the intrinsic polarizer.

In yet another aspect, disclosed herein is an optical element comprising: a support layer having a birefringence of less than 1×10⁻⁶, a Tg of greater than 50° C., an index of refraction of from 1.45 to 1.80, and a light transmission of greater than about 85% over the visible spectrum; an intrinsic polarizer encapsulated in the support layer; and first and second optically clear substrates disposed on opposing outer surfaces of the support layer.

In yet another aspect, a method of forming an optical element is disclosed herein. The method comprises: (A) providing an intrinsic polarizer with a first major surface and a second major surface; (B) applying to at least one of the first and second major surfaces a layer of a curable composition comprising: (a) from 50 to 99 parts by weight of a (meth)acryloyl oligomer having a plurality of pendant, free radically polymerizable functional groups and a Tg of greater than or equal to 20° C., (b) from 1 to 50 parts by weight of a free-radically polymerizable crosslinking agent and/or diluent monomer, and (c) from 0.001 to 5 parts by weight of an initiator; and (C) curing the layer of the curable composition with UV light to form a cured support layer.

In yet another aspect, a projector system is disclosed herein. The projector system comprises a light source and the optical element described herein.

These and other aspects of the invention are described in the detailed description below. In no event should the above summary be construed as a limitation on the claimed subject matter which is defined solely by the claims as set forth herein.

### BRIEF DESCRIPTION OF THE DRAWINGS

The details of one or more embodiments of the invention are set forth in the accompanying drawings and the description below. Other features, objects, and advantages of the invention will be apparent from the description and drawings, and from the claims.

FIG. 1 is a schematic, cross-sectional view of a known conventional construction of an optical element including a polarizer.

FIG. 2 is a schematic, cross-sectional view of an optical element including a polarizer.

FIG. 3 is a schematic, cross-sectional view of an optical element including a polarizer.

FIGS. 4A and 4B are schematic, cross-sectional views of optical elements including a polarizer and a support layer.

FIG. 5 is a schematic representation of an embodiment of an optical projection system.

FIG. 6 is a schematic representation of another embodiment of a display system.

FIGS. 7A and 7B are schematic representations of a test apparatus.

### DETAILED DESCRIPTION

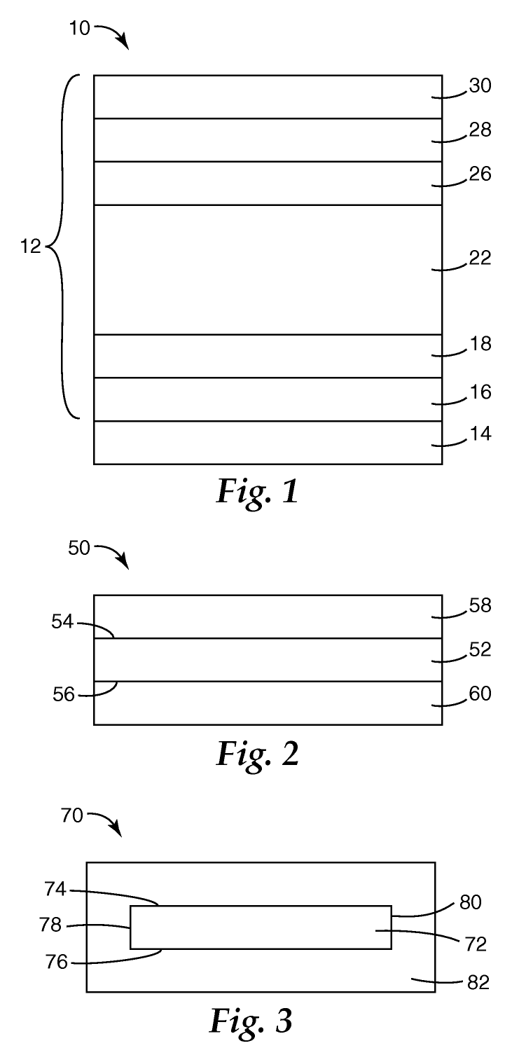

Numerous problems are associated with the use of conventional optical elements such as those shown in FIG. 1. For example, the support layers for the polarizer, as well as the pressure sensitive adhesives used to bond the support layers to the polarizer and other optical members, tend to degrade over time. This is especially the case in projection and other display applications in which optical elements are exposed to high temperatures and intense light flux over extended periods. Degradation can cause the support layers to become increasingly yellow, which reduces the brightness and overall optical performance of the polarizing optical element and the display system.

Another problem associated with conventional optical elements such as those shown in FIG. 1 is that they do not dissipate heat well, and prolonged exposure to high temperatures and high light flux may cause the support layers and/or the adhesive layers to crack and delaminate, which further deteriorates the performance of the display system. The materials used to form the support layers in the optical elements are also birefringent, which reduces optical performance. In addition, the large number of optical interfaces caused by the adhesive layers in the optical element can cause reflective losses in the display system, which reduces the overall brightness of the display. Still yet another problem associated with conventional optical elements such as those shown in FIG. 1 is that they are difficult to handle during manufacture and may be difficult to clean without damaging the support layers.

In general, the present disclosure is directed to an optical element including an intrinsic polarizer having on at least one major surface thereof a support layer having a number of desirable properties. The support layer is made of a cured composition that has good optical properties such as low yellowing, low birefringence, high transmission of visible light, appropriate mechanical properties such as high modulus of elasticity at elevated temperatures, and low coefficient of thermal expansion. The cured composition has a suitable viscosity and adhesion for use as an optical adhesive, which makes possible the elimination of adhesive layers in the optical element. In a preferred embodiment, the polarizer and support layer may be laminated to glass, which provides improved physical and thermal stability that may be necessary for projectors and other display systems.

The support layer comprising the cured composition can act as a buffer, which secures the polarizer in place, minimizing contraction and expansion of the polarizer. In addition, the support layer does not tend to degrade and turn yellow or crack when repeatedly exposed to intense heat, high light flux and thermal gradients during display operation. Therefore, compared to conventional support layers, the support layer described herein can simplify display manufacture and maintain the integrity of the optical performance of the display device for a longer period of time. Compared to conventional support materials such as cellulose triacetate, the support layer described herein has a refractive index that is well matched to the other optical members in the display device, which reduces interface reflection losses and reduces scattering losses, and enhances transmission to provide a brighter display.

FIG. 2 shows an optical element 50 that includes a polarizer 52, typically a polymeric film, with opposed major surfaces 54 and 56. A support layer 58 lies on the first major surface 54 of the polarizer 52; this support layer protects the polarizer 52 against mechanical stress, thermal degradation and environmental contamination. Preferably, a second support layer 60 of the same or a different curable composition may be applied to the second major surface 56 of the polarizer 52; this second support layer further protects the polarizer 52 against mechanical stress, thermal degradation and environmental contamination.

The polarizer 52 may vary widely depending on the intended application, and suitable polarizers include absorptive dichroic plane polarizing films like H-type (iodine) polarizers and dyestuff polarizers, as well as intrinsic polarizers like K-type polarizers and KE-type polarizers. Intrinsic polarizers polarize light due to the inherent chemical structure of the base material used to form the polarizer. The polarizer 52 may optionally be colored, or a surface treatment may be applied to enhance adhesion to adjacent optical members or support layers. Intrinsic polarizers are preferred, and KE-type polarizers, such as those available from 3M Co., St. Paul, Minn., are particularly preferred for their excellent performance under severe environmental conditions. KE-type polarizers have excellent resistance to high temperatures for extended periods of time, which makes them a preferred choice for use in display and projection systems. Such intrinsic polarizers are also typically thin and durable. A K-type polarizer is a synthetic dichroic plane polarizer based on molecularly oriented polyvinyl alcohol sheets or films with a balanced concentration of light-absorbing chromophores. A K-type polarizer derives its dichroism from the light absorbing properties of its matrix, not from the light-absorbing properties of dye additives, stains, or suspended crystalline materials. Thus, a K-type polarizer may have both good polarizing efficiency and good heat resistance. A K-type polarizer may also be very neutral with respect to color. An improved K-type polarizer, referred to as a KE-type polarizer, has improved polarizer stability under severe environmental conditions, such as high temperatures. In contrast to H-type polarizers, in which the light absorption properties are due to the formation of a chromophore between polyvinyl alcohol and tri-iodide ion, KE-type polarizers are made by chemically reacting the polyvinyl alcohol by an acid catalyzed, thermal dehydration reaction. The resulting chromophore, referred to as polyvinylene, and the resulting polymer may be referred to as a block copolymer of vinylalcohol and vinylene. Intrinsic, K-type and KE-type polarizers are discussed further in U.S. Pat. No. 5,666,223; US 2003/0002154; and US 2006/0139574 A1, the disclosures of which are incorporated herein by reference in their entirety. For display applications and in some embodiments, a KE-type polarizer layer 52 has a thickness in a range from about 5 μm to about 100 μm, or 10 to 50 μm, or 25 to 40 μm, and preferably about 20 μm.

The support layer 58 is made from a curable composition that has a combination of physical and optical properties that are well suited for use in optical devices, particularly projection systems. The support layer 58 should preferably have physical properties such as, for example, a coefficient of thermal expansion selected to minimize the overall stress in the optical element 50. For example, the curable composition preferably has volume shrinkage of less than about 10%, more preferably less than about 5%, during the curing process. Appropriate selection of physical properties may extend the life of the optical element and provide higher optical performance. Once the curable composition is cured to form the support layer 58, the support layer 58 protects the adjacent polarizer from mechanical and environmental stress. If not minimized, these stresses may cause dimensional changes in the polarizer that have an adverse impact on the optical performance of the optical element, as well as providing structural damage to the polarizer, such as cracking. Once cured, the support layer has a Tg of >20° C., preferably >50° C., and more preferably >80° C. This Tg ensures that the cured support layer has excellent thermal stability and will not soften, warp, crack or delaminate from an adjacent layer such as a substrate described below, under the extreme temperature conditions and high light flux experienced in an optical device such as a projection system. The support layer (after curing) has a modulus of elasticity, E, >10 MPa at a temperature of 110° C., preferably >30 MPa at a temperature of 110° C., and more preferably >50 MPa at a temperature of 110° C. Also, the support layer (after curing) has a fracture toughness (K_{1c}) greater than 0.20 (MPa)(m^{1/2}) and preferably greater than 0.40 (MPa)(m^{1/2}). In one embodiment, the support layer has a Tg of greater than 50° C. and a modulus of elasticity of at least 50 MPa at a temperature of 110° C.

In addition to having a low yellowing property, the support layer 58 has low transmission loss with exposure, which shows that the optical properties of this material will not degrade with high heat loads or high light flux. Excess heat in the polarizer material eventually leads to a breakdown in polarizer performance, and consequently projector performance. The support layer 58 has excellent optical properties, including a birefringence less than about 1×10⁻⁶, an index of refraction of 1.45 to 1.80; and a light transmission of greater than about 85% over the visible spectrum, and preferably greater than 90% over the visible spectrum. As used herein, visible spectrum refers to the wavelength region of from about 400 nm to about 700 nm. When exposed to heat and light for extended periods, the optical properties of the support layer 58 are substantially unaffected. For previous polarizers, as noted above with respect to FIG. 1, the structure contains layer(s) of cellulose triacetate. It is well known that cellulose triacetate yellows with exposure to heat and light in a projection system, often resulting in reduced transmission of blue light. Yellowing of projection displays is best observed when projecting a uniform white light pattern on a screen, preferably a white or gray screen. The yellow appearance can be seen as a change in the white color displayed on the screen. To measure this, the chromaticity at various points on the screen can then be measured and the white point or white color uniformity can be determined using methods described by 1997 ANSI standard ANSI/NAPM IT7.228-1997 or a variety of other ways that determine the variation of the color across the projected image on a screen. Typical representations of color uniformity include 1931 CIE Δx and Δy coordinates and 1976 CIE delta u′ and delta v′. Each display manufacturer will determine the acceptable level of uniformity but typically, acceptable variation in Δx and Δy is less than 0.015 for Δx and 0.015 for Δy for many center white points. For example, one of the causes of yellowing of high temperature polysilicon (HTPS) projection displays over time is due to a reduction or change in the blue channel polarizer's transmission characteristics caused by long term exposure to heat and light over time. The average transmission over a wavelength range of the blue channel polarizer(s) decreases and the spectral content may also change. The transmission loss can also be represented as a % transmission change at a given wavelength; e.g., % T at 440 nm. Changes to the blue channel's light output affects the color balance in the projector and can result in a yellow appearance when a white screen is displayed.

One composition suitable to form the support layer 58 is described in U.S. application Ser. No. 11/276,068, filed on Feb. 13, 2006, the disclosure of which is herein incorporated by reference in its entirety. This curable composition includes one or more oligomers, preferably (meth)acryloyl oligomers having a plurality of pendent, free-radically polymerizable functional groups and a Tg of greater than or equal to 20° C., preferably greater than or equal to 50° C. The oligomer may be selected from poly(meth)acrylate, polyurethane, polyepoxide, polyester, polyether, polysulfide, and polycarbonate oligomers. The composition used to form the support layer also preferably includes a free-radically polymerizable crosslinking agent and/or a diluent monomer, and an initiator. Selection of the molecular weight of the oligomer and the loading of the crosslinker and/or reactive diluent may be made so that the curable composition exhibits minimal shrinkage and birefringence in the cured reaction product. The low shrinkage of the curable composition is particularly useful in molding applications or in any applications where accurate molding and/or registration is required. It may be formulated as 100% solids and is cured by free-radical processes.

The curable composition is low in viscosity and suitable for molding processes, including precision molding processes. The curable composition generally has a viscosity less than 20,000 centipoise, less than 15,000 centipoise, or less than 10,000 centipoise at application temperatures of 100° C. or less. The curable composition generally has a viscosity of at least 100 centipoise, or at least 500 centipoise, at application temperatures of 100° C. or less.

The support layer generally comprises a reaction product of: (a) from 50 to 99 parts by weight of a (meth)acryloyl oligomer having a plurality of pendant, free radically polymerizable functional groups and a Tg of greater than or equal to 20° C., (b) from 1 to 50 parts by weight of a free-radically polymerizable crosslinking agent and/or diluent monomer, and (c) from 0.001 to 5 parts by weight of an initiator.

The (meth)acryloyl oligomer may be present in an amount of from 60 to 95 parts by weight, or from 70 to 95 parts by weight and may have a Tg of greater than or equal to 50° C. The free-radically polymerizable crosslinking agent and/or a diluent monomer may be present in an amount of from 5 to 40 parts by weight, or from 5 to 30 parts by weight. If used, the free-radically polymerizable crosslinking agent may be present in an amount of from 1 to 40 parts by weight, from 1 to 30 parts by weight, or from 1 to 20 parts by weight. If used, the diluent monomer may be present in an amount of less than 25 parts by weight, less than 15 parts by weight, or less than 10 parts by weight. The initiator may be present in an amount of from 0.001 to 1 parts by weight, or from 0.01 to 0.1 parts by weight based on 100 parts by weight of oligomer and crosslinking agent and/or reactive diluent monomer.

The pendent, free radically polymerizable functional groups may be selected from the group consisting of acyroyl and methacryloyl groups, and includes acrylate, methacrylate, acrylamide and methacrylamide groups. The oligomer may be selected from poly(meth)acrylate, polyurethane, polyepoxide, polyester, polyether, polysulfide, and polycarbonate oligomers. As used herein, (meth)acryloyl groups refers to both acryloyl and methacryloyl groups, and includes acrylate, methacrylate, acrylamide and methacrylamide groups.

The (meth)acryloyl oligomer may comprise the reaction product of: (a) from 50 to 99 parts by weight of (meth)acrylate ester monomer units homopolymerizable to a polymer having a Tg of greater than or equal to 20° C., (b) from 1 to 50 parts by weight of monomer units having a pendent, free-radically polymerizable functional group, and (c) less than 40 parts by weight of monomer units homopolymerizable to a polymer having a glass transition temperature of less than 20° C., based on 100 parts by weight of a) and b). In some cases, the (meth)acrylate ester monomer units are homopolymerizable to a polymer having a Tg of greater than or equal to 50° C. In one embodiment, the support layer comprises a reaction product of: (a) from 75 to 85 parts by weight of a (meth)acryloyl oligomer having a plurality of pendant, free radically polymerizable functional groups and a Tg of greater than or equal to 20° C., (b) from 15 to 25 parts by weight of a free-radically polymerizable crosslinking agent and/or diluent monomer, and (c) from 0.001 to 5 parts by weight of an initiator.

(Meth)acrylated urethanes are multifunctional (meth)acrylate esters of hydroxy terminated isocyanate extended polyols, polyesters or polyethers. (Meth)acrylated urethane oligomers can be synthesized, for example, by reacting a diisocyanate or other polyvalent isocyanate compound with a polyvalent radical polyol (including polyether and polyester polyols) to yield an isocyanate terminated urethane prepolymer. A polyester polyol can be formed by reacting a polybasic acid (e.g., terephthalic acid or maleic acid) with a polyhydric alcohol (e.g., ethylene glycol or 1,6-hexanediol). A polyether polyol useful for making the acrylate functionalized urethane oligomer can be chosen from, for example, polyethylene glycol, polypropylene glycol, poly(tetrahydrofuran), poly(2-methyl-tetrahydrofuran), poly(3-methyl-tetrahydrofuran) and the like. Alternatively, the polyol linkage of an acrylated urethane oligomer can be a polycarbonate polyol.

Subsequently, (meth)acrylates having a hydroxyl group can then be reacted with the terminal isocyanate groups of the prepolymer. Both aromatic and the preferred aliphatic isocyanates can be used to react with the urethane to obtain the oligomer. Examples of diisocyanates useful for making the acrylated oligomers are 2,4-tolylene diisocyanate, 2,6-tolylene diisocyanate, 1,3-xylylene diisocyanate, 1,4-xylylene diisocyanate, 1,6-hexane diisocyanate, isophorone diisocyanate and the like. Examples of hydroxy terminated acrylates useful for making the acrylated oligomers include, but are not limited to, 2-hydroxyethyl (meth)acrylate, 2-hydroxypropyl (meth)acrylate, 4-hydroxybutyl acrylate, polyethylene glycol (meth)acrylate and the like.

A (meth)acrylated urethane oligomer can be, for example, any urethane oligomer having at least two acrylate functionalities and generally less than about six functionalities. Suitable (meth)acrylated urethane oligomers are also commercially available such as, for example, those known by the trade designations PHOTOMER 6008, 6019, 6184 (aliphatic urethane triacrylates) available from Henkel Corp.; EBECRYL 220 (hexafunctional aromatic urethane acrylate of 1000 molecular weight), EBECRYL 284 (aliphatic urethane diacrylate of 1200 molecular weight diluted with 12% of 1,6-hexanediol diacrylate), EBECRYL 4830 (aliphatic urethane diacrylate of 1200 molecular weight diluted with 10% of tetra ethylene glycol diacrylate), and EBECRYL 6602 (trifunctional aromatic urethane acrylate of 1300 molecular weight diluted with 40% of trimethylolpropane ethoxy triacrylate), available from UCB Chemical; and SARTOMER CN1963, 963E75, 945A60, 963B80, 968, and 983) available from Sartomer Co., Exton, Pa.

Alternatively, the acrylate functionalized oligomers can be polyester acrylate oligomers, acrylated acrylic oligomers, polycarbonate acrylate oligomers or polyether acrylate oligomers. Suitable acrylated acrylic oligomers include, for example, commercially available products such as EBECRYL 745 and 1710 both of which are available from UCB Chemicals (Smyrna, Ga.). Useful polyester acrylate oligomers include CN293, CN294, and CN2250, 2281, 2900 from Sartomer Co. (Exton, Pa.) and EBECRYL 80, 657, 830, and 1810 from UCB Chemicals (Smyrna, Ga.). Suitable polyether acrylate oligomers include CN501, 502, and 551 from Sartomer Co. (Exton, Pa.). Useful polycarbonate acrylate oligomers can be prepared according to U.S. Pat. No. 6,451,958 (Sartomer Technology Company Inc., Wilmington, Del.).

(Meth)acrylated epoxies are multifunctional (meth)acrylate esters of epoxy resins, such as the (meth)acrylated esters of bisphenol-A epoxy resin. Examples of commercially available acrylated epoxies include those known by the trade designations EBECRYL 600 (bisphenol A epoxy diacrylate of 525 molecular weight), EBECRYL 605 (EBECRYL 600 with 25% tripropylene glycol diacrylate), EBECRYL 3700 (bispenol A diacrylate of 524 molecular weight) and EBECRYL 3720H (bisphenol A diacrylate of 524 molecular weight with 20% hexanediol diacrylate) available from UCB Chemical, Smyrna, Ga.; and PHOTOMER 3016 (bisphenol A epoxy acrylate), PHOTOMER 3016-40R (epoxy acrylate and 40% tripropylene glycol diacrylate blend), and PHOTOMER 3072 (modified bisphenol A acrylate, etc.) available from Henkel Corp., Hoboken, N.J.

In a preferred embodiment, the oligomer generally comprises polymerized acryloyl monomer units comprising: (a) 50 to 99 parts by weight, preferably 60 to 97 parts by weight, most preferably 80 to 95 parts by weight of (meth)acryloyl monomer units homopolymerizable to a polymer having a glass transition temperature ≧20° C., preferably ≧50° C., preferably the (meth)acryloyl monomer units are (meth)acrylate monomer units; (b) 1 to 50 parts by weight, preferably 3 to 40 parts by weight, most preferably 5 to 20 parts by weight, of monomer units having a pendent, free-radically polymerizable functional group; and (c) less than 40 parts by weight, preferably less than 30 parts by weight, most preferably less than 20 parts by weight, of monomer units homopolymerizable to a polymer having a glass transition temperature less than 20° C., based on 100 parts by weight of a) and b).

The first component oligomer comprises one or more high Tg monomers, which if homopolymerized, yield a polymer having a Tg greater than 20° C., preferably greater than 50° C. Preferred high Tg monomers are monofunctional (meth)acrylate esters of mono- and bicyclic aliphatic alcohols having at least 6 carbon atoms, and of aromatic alcohols. Both the cycloaliphatic and aromatic groups may be substituted, for example, by C1-6 alkyl, halogen, sulfur, cyano, and the like. Especially preferred high Tg monomers include 3,5-dimethyladamantyl (meth)acrylate; isobornyl (meth)acrylate; 4-biphenyl (meth)acrylate; phenyl (meth)acrylate; benzyl methacrylate; and 2-naphthyl (meth)acrylate; dicyclopentadienyl (meth)acrylate. Mixtures of high Tg monomers may also be used. Providing the monomer can be polymerized with the rest of the monomers that comprise the (meth)acrylate monomers, any high Tg monomer including styrene, vinylesters and the like, can be used. However, the high Tg monomer is typically an acrylate or methacrylate ester.

Other high Tg monomers include C1-C20 alkyl (meth)acrylates such as methyl methacrylate, ethyl methacrylate, isopropyl methacrylate, n-butyl methacrylate, isobutyl methacrylate, t-butyl (meth)acrylate, stearyl methacrylate, cyclohexyl methacrylate, 3,3,5-trimethylcyclohexyl methacrylate, tetrahydrofurfuryl methacrylate, allyl methacrylate, bromoethyl methacrylate; styrene; vinyl toluene; vinyl esters such as vinyl propionate, vinyl acetate, vinyl pivalate, and vinyl neononanoate; acrylamides such as N,N-dimethyl acrylamide, N,N-diethyl acrylamide, N-isopropyl acrylamide, N-octyl acrylamide, and t-butyl acrylamide, and (meth)acrylonitrile. Blends of high Tg monomers may be used.

Most preferred high Tg monomers are selected from linear, branched, cyclo, and bridged cycloaliphatic (meth)acrylates, such as isobornyl (meth)acrylate, cyclohexyl methacrylate, 3,3,5-trimethylcyclohexyl methacrylate, methyl methacrylate, ethyl methacrylate, isopropyl methacrylate, n-butyl methacrylate, isobutyl methacrylate, t-butyl (meth)acrylate, stearyl methacrylate, and mixtures thereof, for their environmental (heat and light) stability.

The first component oligomer of the composition comprises one or more pendent groups that include free-radically polymerizable unsaturation. Preferred pendent unsaturated groups include (meth)acryloyl, (meth)acryloxy, and (meth)acrylamido. Such pendent groups can be incorporated into the polymer in at least two ways. The most direct method is to include among the monomer units of ethylene di(meth)acrylate, 1,6-hexanediol diacrylate (HDDA), or bisphenol-A di(meth)acrylate. Useful polyunsaturated monomers include allyl, propargyl, and crotyl (meth)acrylates, trimethylolpropane triacrylate, pentaerythritol triacrylate, and allyl 2-acrylamido-2,2-dimethylacetate.

Using the “direct method” of incorporating the pendent, free-radically polymerizable functional group, useful functional monomers include those unsaturated aliphatic, cycloaliphatic, and aromatic compounds having up to about 36 carbon atoms that include a functional group capable of free radical addition such as those groups containing a carbon-carbon double bond including vinyl, vinyloxy, (meth)acrylate, (meth)acrylamido, and acetylenic functional groups.

Examples of polyethylenically unsaturated monomers that can be used include, but are not limited to, polyacrylic-functional monomers such as ethylene glycol diacrylate, propylene glycol dimethacrylate, trimethylolpropane triacrylate, 1,6-hexamethylenedioldiacrylate, pentaerythritol di-, tri-, and tetraacrylate, and 1,12-dodecanedioldiacrylate; olefinic-acrylic-functional monomers such as allyl methacrylate, 2-allyloxycarbonylamidoethyl methacrylate, and 2-allylaminoethyl acrylate; allyl 2-acrylamido-2,2-dimethylacetate; divinylbenzene; vinyloxy group-substituted functional monomers such as 2-(ethenyloxy)ethyl (meth)acrylate, 3-(ethynyloxy)-1-propene, 4-(ethynyloxy)-1-butene, and 4-(ethenyloxy)butyl-2-acrylamido-2,2-dimethylacetate, and the like. Useful polyunsaturated monomers, and useful reactive/co-reactive compounds that may be used to prepare a polymer having pendent unsaturation are described in greater detail in U.S. Pat. No. 5,741,543 (Winslow et al.).

Preferred polyunsaturated monomers are those where the unsaturated groups are of unequal reactivity. Those skilled in the art recognize that the particular moieties attached to the unsaturated groups affect the relative reactivities of those unsaturated groups. For example, where a polyunsaturated monomer having unsaturated groups of equal reactivity (e.g., HDDA) is used, premature gellation of the composition must be guarded against by, for example, the presence of oxygen, which acts as a radical scavenger. Conversely, where a polyunsaturated monomer having unsaturated groups of differing reactivities is used, the more reactive group (such as (meth)acrylate as (meth)acrylamido) preferentially is incorporated into the polymer backbone before the less reactive unsaturated group (such as vinyl, allyl, vinyloxy, or acetylenic) reacts to crosslink the composition. The direct method is generally not preferred due to difficulty in control of branching and premature gellation.

An indirect, but preferred, method of incorporating pendent groups that comprise polymerizable unsaturation into the first polymer is to include among the monomer units of the polymer some that comprise a reactive functional group. Useful reactive functional groups include, but are not limited to, hydroxyl, amino (especially secondary amino), oxazolonyl, oxazolinyl, acetoacetyl, carboxyl, isocyanato, epoxy, aziridinyl, acyl halide, and cyclic anhydride groups. Preferred among these are carboxyl, hydroxyl and aziridinyl groups. These pendent reactive functional groups are reacted with unsaturated compounds that comprise functional groups that are co-reactive with the reactive pendent functional group. When the two functional groups react, an oligomer with pendent unsaturation results.

Using the “indirect method” of incorporating the pendent, free-radically polymerizable functional groups, useful reactive functional groups include hydroxyl, secondary amino, oxazolinyl, oxazolonyl, acetyl, acetonyl, carboxyl, isocyanato, epoxy, aziridinyl, acyl halide, vinyloxy, and cyclic anhydride groups. Where the pendent reactive functional group is an isocyanato functional group, the co-reactive functional group preferably comprises a secondary amino or hydroxyl group. Where the pendent reactive functional group comprises a hydroxyl group, the co-reactive functional group preferably comprises a carboxyl, isocyanato, epoxy, anhydride, or oxazolinyl group. Where the pendent reactive functional group comprises a carboxyl group, the co-reactive functional group preferably comprises a hydroxyl, amino, epoxy, isocyanate, or oxazolinyl group. Most generally, the reaction is between nucleophilic and electrophilic functional groups that react by a displacement or condensation mechanism.

Representative examples of useful co-reactive compounds include hydroxyalkyl (meth)acrylates such as 2-hydroxyethyl (meth)acrylate, 4-hydroxybutyl (meth)acrylate, and 2-(2-hydroxyethoxy)ethyl (meth)acrylate; aminoalkyl (meth)acrylates such as 3-aminopropyl (meth)acrylate and 4-aminostyrene; oxazolinyl compounds such as 2-ethenyl-1,3-oxazolin-5-one and 2-propenyl-4,4-dimethyl-1,3-oxazolin-5-one; carboxy-substituted compounds such as (meth)acrylic acid and 4-carboxybenzyl (meth)acrylate; isocyanato-substituted compounds such as isocyanatoethyl (meth)acrylate and 4-isocyanatocyclohexyl (meth)acrylate; epoxy-substituted compounds such as glycidyl (meth)acrylate; aziridinyl-substituted compounds such as N-acryloylaziridine and 1-(2-propenyl)-aziridine; and acryloyl halides such as (meth)acryloyl chloride.

Preferred functional monomers have the general formula

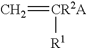

wherein R¹ is hydrogen, a C1 to C4 alkyl group, or a phenyl group, preferably hydrogen or a methyl group; R² is a single bond or a divalent linking group that joins an ethylenically unsaturated group to polymerizable or reactive functional group A and preferably contains up to 34, preferably up to 18, more preferably up to 10, carbon and, optionally, oxygen and nitrogen atoms and, when R² is not a single bond, is preferably selected from

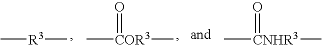

wherein R³ is an alkylene group having 1 to 6 carbon atoms, a 5- or 6-membered cycloalkylene group having 5 to 10 carbon atoms, or an alkylene-oxyalkylene in which each alkylene includes 1 to 6 carbon atoms or is a divalent aromatic group having 6 to 16 carbon atoms; and A is a functional group, capable of free-radical addition to carbon-carbon double bonds, or a reactive functional group capable of reacting with a co-reactive functional group for the incorporation of a free-radically polymerizable functional group.

It will be understood, in the context of the above description of the first component oligomer, that the ethylenically-unsaturated monomer possessing a free-radically polymerizable group is chosen such that it is free-radically polymerizable with the crosslinking agent and reactive diluent. The reactions between functional groups provide a crosslink by forming a covalent bond by free-radical addition reactions of ethylenically-unsaturated groups between components. In the present invention the pendent functional groups react by an addition reaction in which no by-product molecules are created, and the exemplified reaction partners react by this preferred mode.

Where the curable composition is to be processed using high temperatures and the direct method of including pendent unsaturation has been used, care must be taken not to activate those pendent groups and cause premature gelation. For example, hot-melt processing temperatures can be kept relatively low and polymerization inhibitors can be added to the mixture. Accordingly, where heat is to be used to process the composition, the above-described indirect method is the preferred way of incorporating the pendent unsaturated groups.

The oligomer may optionally further comprise lower Tg alkyl (meth)acrylate esters or amides that may be homopolymerized to polymers having a Tg of less than 20° C. Alkyl (meth)acrylate ester monomers useful in the invention include straight-chain, cyclic, and branched-chain isomers of alkyl esters containing C1-C20 alkyl groups. Due to Tg and side chain crystallinity considerations, preferred lower Tg alkyl (meth)acrylate esters are those having from C1-C8 alkyl groups. Useful specific examples of alkyl (meth)acrylate esters include: methyl acrylate, ethyl acrylate, n-propyl acrylate, butyl acrylate, iso-amyl (meth)acrylate, n-hexyl (meth)acrylate, n-heptyl (meth)acrylate, n-octyl (meth)acrylate, iso-octyl (meth)acrylate, 2-ethylhexyl (meth)acrylate, iso-nonyl (meth)acrylate, and decyl (meth)acrylate. Most preferred (meth)acrylate esters include methyl acrylate, ethyl acrylate, butyl acrylate, isooctyl (meth)acrylate, 2-ethylhexyl (meth)acrylate, cyclohexyl acrylate. The lower Tg alkyl (meth)acrylate esters are added in such an amount such that the resulting oligomer has a Tg of 20° C. or greater. In general, such low Tg monomers are used in amounts of 40 parts by weight or less, preferably 30 parts by weight or less, most preferable 20 parts by weight or less.

The theoretical Tg of an oligomer may be calculated, for example, using the Fox equation, 1/Tg=(w1/Tg1+w2/Tg2), where w1 and w2 refer to the weight fraction of the two components and Tg1 and Tg2 refer to the glass transition temperature of the two components, as described for example in L. H. Sperling, “Introduction to Physical Polymer Science”, 2nd Edition, John Wiley & Sons, New York, p. 357 (1992) and T. G. Fox, Bull. Am. Phys. Soc., 1, 123 (1956), which are incorporated herein by reference. Using the Tg of the component monomers, and an estimate of the weight fractions thereof in the oligomer, one may calculate the Tg of the resulting oligomer. As understood by one skilled in the art, the Fox equation may be used for a system with more than two components.

The oligomer may be prepared using radical polymerization techniques by combining an initiator and monomers in the presence of a chain transfer agent. In this reaction, a chain transfer agent transfers the active site on one growing chain to another molecule that can then start a new chain so the degree of polymerization may be controlled. The degree of polymerization of the resulting oligomer may be 10 to 300, preferably 15 to 200, more preferably 20 to 200. It has been found if the degree of polymerization is too high, the composition is too high in viscosity, and not easily melt processible. Conversely, if the degree of polymerization is too low, the shrinkage of the cured composition is excessive and leads to high birefringence in the cured composition.

Chain transfer agents may be used when polymerizing the monomers described herein to control the molecular weight of the resulting oligomer. Suitable chain transfer agents include halogenated hydrocarbons (e.g., carbon tetrabromide) and sulfur compounds (e.g., lauryl mercaptan, butyl mercaptan, ethanethiol, and 2-mercaptoethyl ether, isooctyl thioglycolate, t-dodecylmercaptan, 3-mercapto-1,2-propanediol). The amount of chain transfer agent that is useful depends upon the desired molecular weight of the oligomer and the type of chain transfer agent. The chain transfer agent is typically used in amounts from about 0.1 parts to about 10 parts; preferably 0.1 to about 8 parts; and more preferably from about 0.5 parts to about 6 parts based on total weight of the monomers.

In some embodiments, multifunctional chain transfer agents having two or more functional groups can be used to produce compounds having two or more oligomeric groups. The use of multifunctional chain transfer agents result in higher fracture toughness after cure. Examples of multi-functional chain transfer agents include trimethylolpropane tris(2-mercaptoacetate), trimethylolpropane tris(3-mercaptopropionate), pentaerythritol tetrakis(2-mercaptoacetate), pentaerythritol tetrakis(3-mercaptopropionate), ethylene glycol bis(3-mercaptopropionate), dipentaerythritol hexakis(3-mercaptopropionate), 1,4-butanediol bis(3-mercaptopropionate), tris[2-(3-mercaptopropionyloxy)ethyl]isocyanureate, tetraethylene glycol bis(3-mercaptopropionate), ethylene glycol bisthioglycolate, trimethylolethane trithioglycolate, 1,4-butanediol bismercaptoacetate, and glyceryl thioglycolate, or combinations of these materials. The multi-functional chain transfer agents can also be derived from α,ω-mercaptoalkanes or α,ω-allyl alkanes as known in the art and include 1,10-dimercaptodecane, α,ω-dimercapto tetradecane, 1,10-diallyl decane. Other chain transfer agents comprise α, ω-halogen substituted alkanes such as α,α,α,ω,ω,ω-hexabromodecane. Reference may be made to U.S. Pat. No. 6,395,804 and U.S. Pat. No. 6,201,099 (Peterson et al.) incorporated herein by reference.

Suitable initiators for this oligomerization reaction include, for example, thermal and photo initiators. Useful thermal initiators include azo compounds and peroxides. Examples of useful azo compounds include 2,2′-azobis(2,4-dimethylpentanenitrile), (Vazo 52, commercially available from E.I. duPont de Nemours & Co.); 2,2′-azobis(isobutyronitrile), (Vazo 64, commercially available from E.I. duPont de Nemours & Co.); 2,2′-azobis(2-methylbutyronitrile), (Vazo 67, commercially available from E.I. duPont de Nemours & Co.); 1,1′-azobis(cyanocyclohexane), (Vazo 88, commercially available from E.I. duPont de Nemours & Co.); 1,1′-azobis(1-cyclohexane-1-carbonitrile), (V-40, commercially available from Wako Pure Chemical Industries, Ltd.); and dimethyl 2,2′-azobis(isobutyrate), (V-601, commercially available from Wako Pure Chemical Industries, Ltd.). Examples of useful peroxides include benzoyl peroxide; di-t-amyl peroxide, t-butyl peroxy benzoate, 2,5-dimethyl-2,5 Di-(t-butylperoxy)hexane, 2,5-dimethyl-2,5-Di-(t-butylperoxy)hexyne-3, lauroyl peroxide, and t-butyl peroxy pivalate. Useful organic hydroperoxides include but are not limited to compounds such as t-amyl hydroperoxide and t-butyl hydroperoxide.

Useful photoinitiators include benzoin ethers such as benzoin methyl ether and benzoin butyl ether; acetophenone derivatives such as 2,2-dimethoxy-2-phenyl-acetophenone and 2,2-diethoxy acetophenone; and acylphosphine oxide derivatives and acylphosphonate derivatives such as diphenyl-2,4,6-trimethylbenzoylphosphine oxide, isopropoxy(phenyl)-2,4,6-trimethylbenzoylphosphine oxide, and dimethyl pivaloylphosphonate. Of these, 2,2-dimethoxy-2-phenyl-acetophenone is preferred. The initiator is typically used at a level of 0.001 to 5 parts by weight per 100 parts by weight monomer(s).

The composition further comprises a crosslinking agent having a plurality of pendent, ethylenically unsaturated, free-radically polymerizable functional groups. Useful crosslinking agents have an average functionality (average number of ethylenically unsaturated, free-radically polymerizable functional groups per molecule) of greater than one, and preferably greater than or equal to two. The functional groups are chosen to be copolymerizable with the pendent ethylenically unsaturated, free-radically polymerizable functional groups on the first component oligomer. Useful functional groups include those described for the first component oligomer and include, but are not limited to vinyl, vinyloxy, (meth)acryloyl and acetylenic functional groups.

Useful crosslinking agents have the general formula:

R-(Z)ₙ

where Z is a free-radically polymerizable functional group such as a carbon-carbon double bond, n is greater than 1 and R is an organic radical having a valency of n. Preferably R is an aliphatic alkyl radical of valency n which may be linear or branched.

Examples of such crosslinking agents include: C2-C18 alkylenediol di(meth)acrylates, C3-C18 alkylenetriol tri(meth)acrylates, such as 1,6-hexanediol di(meth)acrylate, trimethylolpropane tri(meth)acrylate, propoxylated trimethylolpropane triacrylate such as CD501 from Sratomer Co., Exton, Pa., triethyleneglycol di(meth)acrylate, pentaeritritol tri(meth)acrylate, and tripropyleneglycol di(meth)acrylate, and di-trimethylolpropane tetraacrylate, polyalkyleneglycol dimethacrylate such as BISOMER EP100DMA from Cognis Co. For ease of mixing, the preferred crosslinking agent is not a solid material at application temperatures.

The composition according to the invention may comprise at least one reactive diluent. The reactive diluents can be used to adjust the viscosity of the composition. Thus, the reactive diluents can each be a low viscosity monomer containing at least one functional group capable of polymerization when exposed to actinic radiation. For example, vinyl reactive diluents and (meth)acrylate monomer diluents may be used.

The functional group present on the reactive diluents may be the same as that used in the curable (meth)acrylate oligomer. Preferably, the radiation-curable functional group present in the reactive diluent is capable of copolymerizing with the radiation-curable functional group present on the radiation-curable oligomer. The reactive diluents generally have a molecular weight of not more than about 550 or a viscosity at room temperature of less than about 500 mPa.sec (measured as 100% diluent).

The reactive diluent may comprise monomers having a (meth)acryloyl or vinyl functionality and a C1-C20 alkyl moiety. Examples of such reactive diluents are ethyl (meth)acrylate, isopropyl (meth)acrylate, t-butyl (meth)acrylate, n-butyl (meth)acrylate, cyclohexyl (meth)acrylate, isobornyl (meth)acrylate, isooctyl (meth)acrylate, 2-ethylhexyl (meth)acrylate, stearyl (meth)acrylate, phenoxyethyl (meth)acrylate, benzyl (meth)acrylate and the like. Low volatile alkyl (meth)acrylates such as isobornyl (meth)acrylate, 2-ethylhexyl (meth)acrylate, cyclohexyl (meth)acrylate, isooctyl (meth)acrylate, stearyl (meth)acrylate, phenoxyethyl (meth)acrylate, benzyl (meth)acrylate are preferred reactive diluents.

The reactive diluent is preferably added in such an amount that the volume shrinkage of the cured compositions does not exceed around 10%, preferably not above around 5%. Suitable amounts of the reactive diluents have been found to be less than about 40 parts by weight, preferably about 0 to about 30 parts by weight, and more preferably about 0 to about 20 parts by weight. Preferably, the sum of the amounts of the reactive diluent and the crosslinking agent is less than 40 parts by weight.

The components of the composition may be combined and cured with a photoinitiator. The photoinitiator improves the rate of cure and percent conversion of the curable compositions, but the depth of cure (of thicker coatings or shaped articles) may be deleteriously affected as the photoinitiator may attenuate the transmitted light that penetrates the thickness of the sample. The photoinitiator is used in an amount of less than 1.0 weight %, preferably less than 0.1 weight %, most preferably less than 0.05 weight %.

Conventional photoinitiators can be used. Examples include benzophenones, acetophenone derivatives, such as α-hydroxyalkylphenylketones, benzoin alkyl ethers and benzil ketals, monoacylphosphine oxides, and bis-acylphosphine oxides. Preferred photoinitiators are ethyl 2,4,6-trimethylbenzoylphenyl phosphinate (LUCIRIN TPO-L) available from BASF, Mt. Olive, N.J., 2-hydroxy-2-methyl-1-phenyl-propan-1-one (IRGACURE 1173™, Ciba Specialties), 2,2-dimethoxy-2-phenyl acetophenone (IRGACURE 651 ™, Ciba Specialties), phenyl bis-(2,4,6-trimethyl benzoyl) phosphine oxide (IRGACURE 819, Ciba Specialities). Other suitable photoinitiators include mercaptobenzothiazoles, mercaptobenzooxazoles and hexaryl bisimidazole. Often, mixtures of photoinitiators provide a suitable balance of properties.

The curable composition can then be applied to the desired substrate or added to a mold and exposed to actinic radiation such as UV light. The composition may be exposed to any form of actinic radiation, such as visible light or UV radiation, but is preferably exposed to UVA (320 to 390 nm) or UVB (395 to 445 nm) radiation. Generally, the amount of actinic radiation should be sufficient to form a non-tacky, dimensionally stable solid mass. Generally, the amount of energy required for curing the composition ranges from about 0.2 to 20.0 J/cm².

Any suitable light source may be used for photopolymerization, including carbon arc lights, low, medium, or high pressure mercury vapor lamps, swirl-flow plasma arc lamps, xenon flash lamps, ultraviolet light emitting diodes, and ultraviolet light emitting lasers. For many applications it may be desirable to use an LED light source or array to effect the curing. Such LED sources may reduce cure times and provide less heat to the composition during cure. One suitable LED source is the Norlux large area array, series 808 (available from Norlux, Carol Stream, Ill.).

In another embodiment of an optical element 70 shown in FIG. 3, a polarizer 72 includes a first major surface 74 and an opposed second major surface 76, as well as generally opposed edges 78 and 80. To encapsulate the polarizer 72, the support layer 82 covers not only the major surfaces 74, 76 of the polarizer 72, but also covers the edges 78, 80. The support layer 82 may be applied to any of the major surfaces 74, 76 and the edges 78, 80 of the polarizer 72 as individual cured pieces, or the curable composition may be poured around the polarizer 72 and subsequently cured. It should be noted that the polarizer 72 may be encapsulated using the same material on the major surfaces 74, 76 and the edges 78, 80 of the polarizer, or alternatively, a different material may be used to seal the edges 78, 80 of the material than is used to cover the major surfaces 74 and 76.

The “encapsulated” optical element 70 described in FIG. 3 has excellent environmental resistance. Both the optical element 50, illustrated in FIG. 2 and the optical element 70, illustrated in FIG. 3 have an advantage in being very thin, and can have a thickness of less than about 0.5 mm, more preferably a thickness of about 0.2 mm, which makes it suitable for use in small displays.

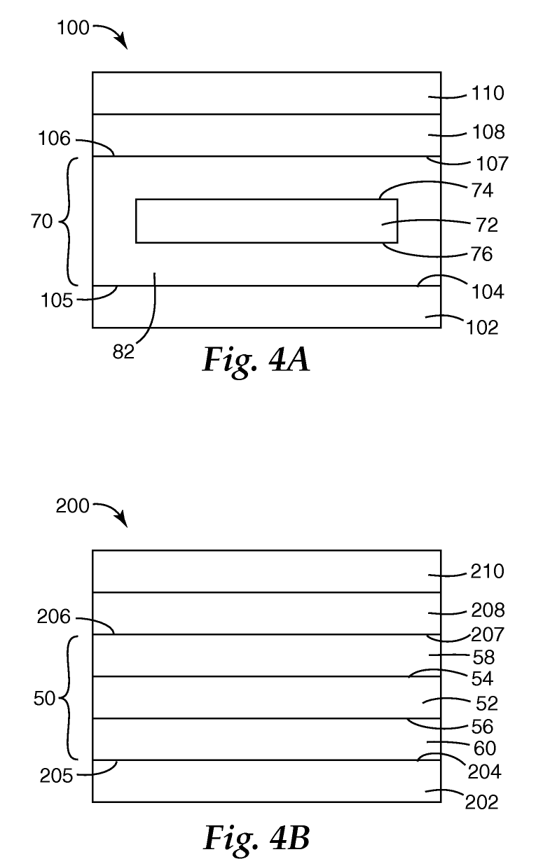

An optical element 100 shown in FIG. 4A includes the encapsulated polarizer construction 70 from FIG. 3. In the optical element 100, the polarizer construction 70 is mounted on a first optically clear supporting substrate 102, which contributes to maintaining the physical integrity of the optical element 100 and may serve as a thermal dissipative layer to transfer heat caused by absorption of light and projector operating temperatures. One way to evaluate the relative ability to transfer heat away from the polarizer is to evaluate the substrate temperature of the optical element in a projector environment and compare this temperature to similar polarizer materials in the same environment.

The substrate 102 may be selected from any optically clear material, and is typically glass. Suitable materials include fused silica, sapphire glass, quartz glass, borosilicate glass, or ceramic glasses. Polymeric materials such as, for example, polymethylmethacrylates (PMMA), polycarbonates (PC), and norbornene-based cyclic olefin copolymer films are also suitable for the substrate 102.

The support layer 82 that is secured to the polarizer 72 is mounted on a first major surface 104 of the first supporting substrate 102. A surface treatment such as, for example, a silane treatment, may optionally be applied to the first major surface 104 of the substrate 102, or to the mating surface 105 of the support layer 82, to enhance adhesion between the substrate 102 and the support layer 60. Optionally, an adhesive layer (not shown in FIG. 4A) may be used, but such additional layers are not preferred because they increase the number of optical interfaces, which typically reduces the optical performance of the optical element 100.

An optional second supporting substrate 108 may also be used to further support and sandwich the support layer 82 and the encapsulated polarizer 72. The second supporting substrate 108 may be made of the same or different materials from the first supporting substrate 102, and in some applications may even be a hard coating of a polymeric material applied directly on the support layer 82. Again, surface treatments may be applied to the mating surfaces 106, 107 of the support layer 82 and the second substrate 108, respectively, to enhance adhesion to other layers. An optional adhesive layer (not shown in FIG. 4) may also be applied between the support layer 82 and the second supporting substrate 108.

An optional anti-reflective coating layer 110 may be applied to the second supporting substrate 108 or directly on the surface 106 of the support layer 82.

Another optical element 200 shown in FIG. 4B includes the polarizer construction 50 from FIG. 2. In the optical element 200, the polarizer construction 50 is mounted on a first optically clear supporting substrate 202, which contributes to maintaining the physical integrity of the optical element 200 and may serve as a thermal dissipative layer. The substrate 202 is typically glass, and suitable materials include fused silica, sapphire glass, quartz glass, borosilicate glass, or ceramic glasses. Polymeric materials are also suitable for the substrate 202.

The first support layer 60 that is secured to the polarizer 52 is mounted on a first major surface 204 of the first supporting substrate 202. A surface treatment such as, for example, a silane treatment, may optionally be applied to the first major surface 204 of the substrate 202, or to the mating surface 205 of the first support layer 60, to enhance adhesion between the substrate 202 and the support layer 60. Optionally, an adhesive layer (not shown in FIG. 4B) may be used, but such additional layers are not preferred because they increase the number of optical interfaces, which typically reduces the optical performance of the optical element 200.

An optional second supporting substrate 208 may also be used to further support and sandwich a second support layer 58 and the polarizer 52. The second supporting substrate 208 may be made of the same or different materials from the first supporting substrate 202, and in some applications may even be a hard coating of a polymeric material applied directly on the second support layer 58. Again, surface treatments may optionally be applied to either of a mating surface 206 of the second support layer 58 or to the mating surface 207 of the second substrate 208 respectively, to enhance adhesion to other layers. An optional adhesive layer (not shown in FIG. 4B) may also be applied between the second support layer 52 and the second supporting substrate 208.

An optional anti-reflective coating layer 210 may be applied to the second supporting substrate 208 or directly on the surface 206 of the support layer 58.

Additional optical layers, not shown in FIGS. 4A-4B, may optionally be applied on the optical elements 100/200 to provide more complex optical constructions for a particular application. Examples useful in LCD displays and projection systems include reflectors, transflectors, retardation plates, viewing angle compensation films, or brightness enhancement films. Additional coatings such as, for example, antireflective coatings, antistatic coatings, protective hard coatings, and the like, may optionally be applied to any of the surfaces in the optical elements 100/200. A particularly useful “quick clean” protective coating includes a monomer of a mono or multi(methyl)acrylate bearing at least one monovalent hexafluoropolypropylene oxide derivative and a free radically reactive compatibilizer consisting of either a fluoroalkyl-group containing acrylate compatibilizer or a fluoroalkylene-group containing acrylate compatibilizer to a conventional hydrocarbon-based hard coat formulation. The resultant coating is substantially smooth and forms a durable surface layer that has low surface energy that is stain and ink repellent and further has good optical qualities.

The optical element 100 may be used in a wide variety of optical devices, and is particularly well suited for use in transmissive, high temperature projection systems where brightness, contrast and color uniformity are important. Typical applications include, for example, front screen projectors suitable for business applications, rear screen projectors suitable for televisions and movie display, and color single panel displays for use in vehicles.

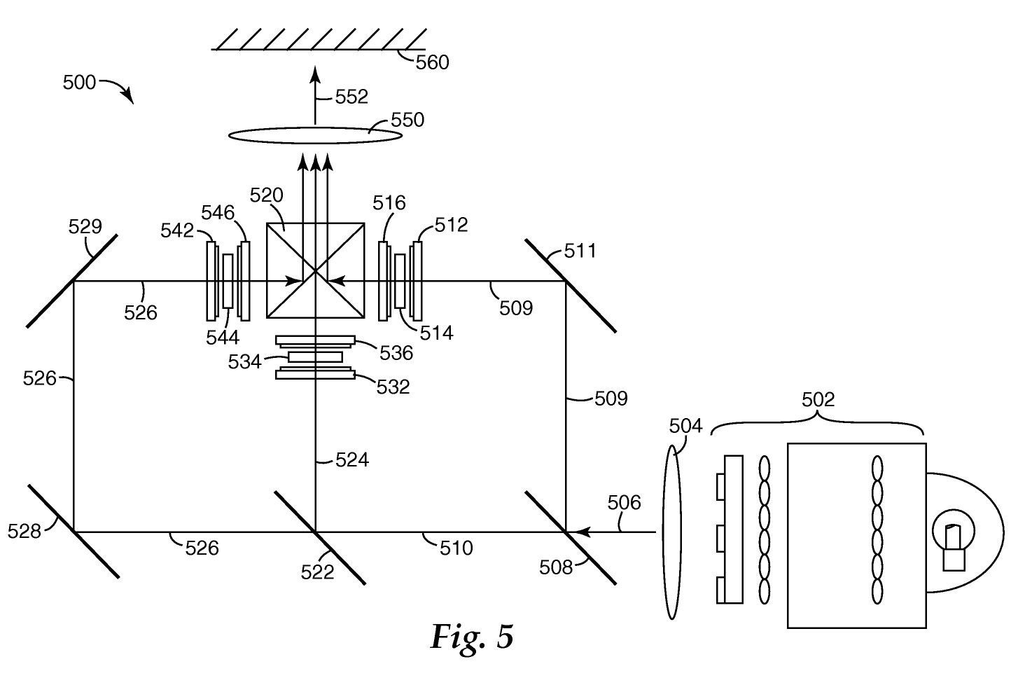

FIG. 5 is a schematic illustration of a projection system 500 that may include any or a combination of the encapsulated polarizer constructions shown in FIG. 2, 3 or 4A-4B above. In the projection system 500 a light source 502 emits light, which is focused by a focusing lens 504. After emerging from the focusing lens 504, the light beam 506 is directed on a beamsplitter 508, which separates the light beam 506 into a blue light beam 509 and a yellow light beam 510.

The blue light beam 509 is reflected by a mirror 511 and enters a blue entrance polarizer 512. Any of the polarizer constructions shown in FIG. 2, 3 or 4A-4B above may be used for the blue entrance polarizer 512. After exiting the blue entrance polarizer 512, the blue light beam 509 enters a blue LCD imager 514, and then enters a blue exit polarizer 516. Again, any of the polarizer constructions shown in FIGS. 2-4 above may be used for the blue exit polarizer 516. After emerging from the blue exit polarizer 516, the blue light beam 509 enters an X-cube 520.

The yellow light beam 510 enters a beamsplitter 522, where it is separated into a green light beam 524 and a red light beam 526. The green light beam 524 then enters a green entrance polarizer 532. Any of the polarizer constructions shown in FIGS. 2-4 above may be used for the green entrance polarizer 532. After exiting the green entrance polarizer 532, the green light beam 524 enters a green LCD imager 534, and then enters a green exit polarizer 536. Again, any of the polarizer constructions shown in FIG. 2, 3 or 4A-4B above may be used for the green exit polarizer 536. After emerging from the green exit polarizer 536, the green light beam 524 enters the X-cube 520.

The red light beam 526 is reflected on a first mirror 528 and a second mirror 529, and then enters a red entrance polarizer 542. Any of the polarizer constructions shown in FIGS. 2-4 above may be used for the red entrance polarizer 542. After exiting the red entrance polarizer 542, the red light beam 526 enters a red LCD imager 544, and then enters a red exit polarizer 546. Again, any of the polarizer constructions shown in FIG. 2, 3 or 4A-4B above may be used for the red exit polarizer 546. After emerging from the red exit polarizer 546, the red light beam 526 enters the X-cube 520.

After being re-combined in the X-cube 520, the blue, green, and red light beams 509, 524 and 526, respectively, exit the X-cube 520 and enter a projection lens 550 for subsequent projection as a projection beam 552 onto a screen 560.

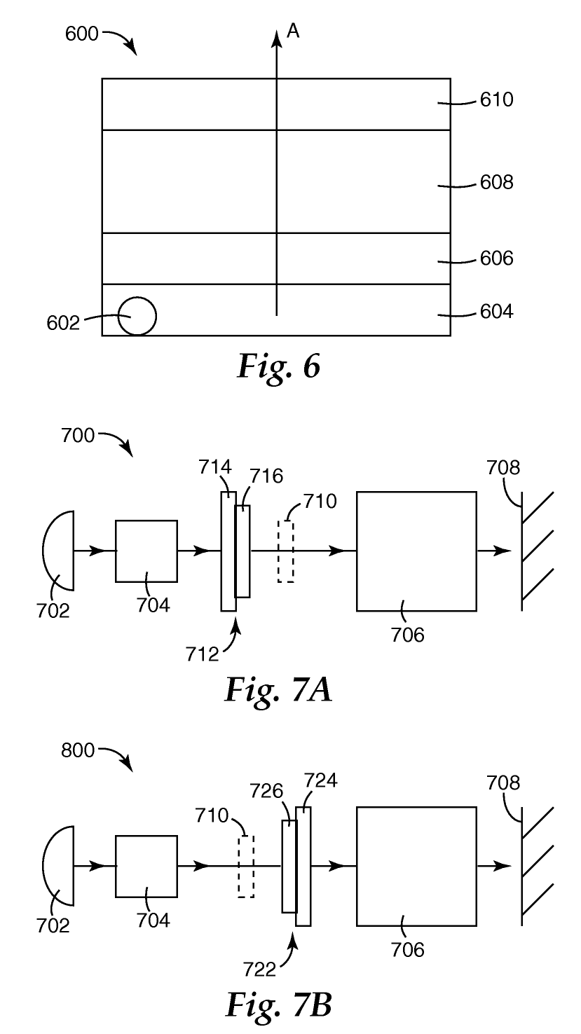

FIG. 6 shows another exemplary optical system 600 that may include the polarizer constructions shown in FIG. 2, 3 or 4A-4B above. The system 600 includes a light source 602 and a backlight layer 604, which provide light along the direction of the arrow A. The light passes through a first polarizer 606, which may be selected from any of the polarizer constructions shown in FIG. 2, 3 or 4A-4B above, and then the polarized light enters a liquid crystal layer 608. The liquid crystal layer 608 typically includes a first glass layer, a passivation layer, an alignment layer, liquid crystal, a metal oxide layer and a second glass layer, but for clarity these sub-layers are not shown in FIG. 6. After the light passes through the liquid crystal layer 608, the light enters a second polarizer 610, which analyzes light to provide image information for the optical element 600. Again, the second polarizer 610 may be selected from any of the polarizer constructions shown in FIG. 2, 3 or 4A-4B above. The optical element 600 may be used, for example, as a touch screen or in a navigation screen for a vehicle.

Since the support layers described above make possible the elimination of adhesive layers and hardcoat layers in the polarizing optical element, the use of the support layers simplifies the manufacture of the optical element.

For example, to make the polarizing optical element exemplified above in FIGS. 4A-4B, two pieces of optical quality glass and a suitably sized piece of a polarizing film, preferably a KE polarizing film, are required. Prior to assembly, the glass and the KE polarizing film are optionally surface treated to enhance adhesion to adjacent layers. For example, for surface treatment the glass and polarizer films may be dipped in a silane solution such as those available under the trade designation A174 Silane from Alfa Aesar, Ward Hill, Mass. The A174 Silane solution includes 3-(methacryloyloxy)propyltrimethoxysilane), acetic acid, and a carrier. Typical carriers include water and organic solvents such as 2-propanol. After dipping in the silane solution, the components are optionally heated to speed the removal of the solvent and dry the components for subsequent handling. For example, the drying process typically includes placing the components in an oven at a temperature of about 120° C. for approximately 15 minutes.

To make an optical element using the silane treated components, an assembly fixture is first heated on a hotplate, typically to about 80° C., and release liners are placed on the surfaces of the assembly fixture. The surface treated glass plates may then be placed on the release liners and several drops of an uncured liquid support layer composition may be placed on the exposed surfaces of the glass substrates. After the suitably sized polarizer film is placed onto one of the areas including the uncured liquid support layer composition, the assembly fixture may be closed to press together the construction and maintain component alignment.

The fixture may then be heated and placed under a UV lamp as necessary to cure the liquid support layer composition and form a support layer between the glass substrates and about the polarizing film. While the curing process conditions may vary widely, typically about a 90 second cure is required on each side of the construction. Suitable curing lamps include those available under the trade designation 808 Die Array UV Lamp from Norlux, Carol Stream, Ill. Presenting light from both sides of the assembly allows for uniform curing of the support layer(s) and in one step, but of course, multiple curing steps may also be used. A small bead of the uncured support layer composition can optionally be applied to any exposed edges of the polarizer film and subsequently cured to seal the edges and form a complete encapsulate.

The invention may be more completely understood in consideration of the following examples.

### EXAMPLES

These examples are for illustrative purposes only and are not meant to limit the scope of the appended claims. All parts, percentages, ratios, etc. in the examples are by weight unless otherwise noted. Reagents used are listed in Table 1 and were obtained from Sigma-Aldrich Chemical Company, Milwaukee, Wis., unless otherwise noted. KE polarizer (about 25 um thickness) was obtained from 3M Company, Norwood, Mass.; preparation of this polarizer is described in US 2006/0139574 A1.

TABLE 1

| Abbreviation or | |
|---|---|
| Trade | |
| Designation | Description |
| IBOA | Isobornyl acrylate, available from Sartomer Company |
| | Inc., Exton, PA |
| HBA | 4-Hydroxybutyl acrylate, available from San Esters |
| | Corporation, NY |
| PETMP | Pentaerythritol tetramercaptopropionate |
| IOTG | Isooctyl thioglycolate, available from TCI America, |
| | Portland, OR |
| MAnh | Methacrylic anhydride |
| VAZO 52 | Thermal initiator, 2,2′-azobis(2,4-dimethylvaleronitrile), |
| | available from DuPont Company, Wilmington, DE |
| VAZO 67 | Thermal initiator, 2,2′-azobis(2-methylbutyronitrile), |
| | available from DuPont Company, Wilmington, DE |
| VAZO 88 | Thermal initiator, 1,1′-azobis(cyanocyclohexane) |
| | available from DuPont Company, Wilmington, DE |
| LUPEROX | Thermal initiator, 2,5-di(t-butylperoxy)-2,5-dimethyl-3- |
| 130XL45 | hexyne, available from Arkema Inc., Philadelphia, PA |
| HDDMA | 1,6-Hexanediol dimethacrylate, SR239, available from |
| | Sartomer Company Inc, Exton, PA |
| BISOMER | Polyalkylene glycol dimethacrylate, available from |
| EP100DMA | Cognis Corp., Cincinnati, OH |
| LUCIRIN | Photoinitiator; ethyl 2,4,6-trimethylbenzoyl phenyl |
| TPO-L | phosphinate, available from BASF, Mt. Olive, NJ |
| IRGANOX | Antioxidant, octadecyl 3,5-di-(tert)-butyl-4- |
| 1076 | hydroxyhydrocinnamate, available from Ciba Specialty |
| | Chemicals Corporation, Tarrytown, NY |
| EBECRYL 600 | Bisphenol-A epoxy diacrylate available from Surface |
| | Specialties UCB, Smyrna, GA |
| EBECRYL 830 | Polyester hexaacrylate available from Surface Specialties |
| | UCB, Smyrna, GA |
| CN 1963 | Aliphatic urethane dimethacrylate blended with |
| | trimethylolpropane trimethacrylate in an approximate |
| | 75:25 ratio available from Sartomer Company, Inc., |
| | Exton, PA |

### Example A

### Example 1

Support Layer Material 1 was prepared as follows. IBOA (180.0 g), HBA (20.0 g), PETMP (6.0 g), and thermal initiators VAZO 52 (0.01 g), VAZO 88 (0.01 g), and LUPEROX 130XL45 (0.01 g), were added to a four neck flask equipped with a reflux condenser, thermometer, mechanical stirrer, and nitrogen gas inlet. The mixture was stirred and heated to 60° C. under nitrogen. The temperature of the reaction mixture peaked at around 180° C. during the polymerization. After the reaction temperature peaked, the mixture was further heated at 140° C. for 30 minutes. The temperature of the mixture was cooled to 120° C. and MAnh (22.8 g) and IRGANOX 1076 (0.42 g) were added. The reaction mixture was stirred for 4 hours at 120° C. followed by addition of HDDMA (28.7 g), BISOMER EP100DMA (28.7 g), and LUCIRIN TPO-L (0.17 g) to give an oligomer mixture as a thick liquid.

An optical element comprising a “sandwich sample”, similar to that shown in FIG. 4A, was prepared as follows. Plates of 1 mm thick fused quartz were cut to 25 mm squares. These were dipped in a solution of 5 wt % water, 2 wt % 3-(methacryloyloxy)propyl-trimethoxysilane, and 0.5 wt % acetic acid in isopropanol. They were rinsed with isopropanol and then dried in an oven at 140° C. for 25 min. Appropriately-sized pieces of KE-type polarizer film were dipped in the same silane solution for 10 s each, and then rinsed with isopropanol. These were then placed in a 100° C. oven for 1 h.

Several drops (0.15-0.4 g) of Support Layer Material 1 were placed on the top surface of the silane-treated fused quartz substrate described above. A suitably sized silane-treated polarizer film was placed onto this uncured liquid support layer. Several more drops (0.15-0.4 g) of Support Layer Material 1 were placed on top of the polarizer film. A second silane-treated glass substrate was placed on top of this stack and pressed down to squeeze out excess liquid. This sandwich assembly was cured using a Norlux 808 375 nm LED array (NAR375808A003 available from Norlux Corporation, Carol Stream, Ill.) with an exposure time of 1 minute. Excess polymer was removed with a razor blade and the glass surfaces of the encapsulated polarizer were cleaned with acetone.

Environmental testing on the optical element was carried out by exposing for 240 hours at 100° C., 240 hours at −60° C./90% relative humidity, 240 hours at −40° C., and 70 thermal cycles of −20° C. to 80° C. (3 hour soak at each temperature with 1 hour ramp in between). Test samples showed no significant mechanical changes in structure relative to delamination and cracking.

### Comparative Example 1

Comparative Example 1 was prepared by adhering KE polarizer to TAC using a UV adhesive (as described in US 2006/0139574 A1). A fused quartz substrate was then adhered to the KE polarizer using an optical pressure sensitive adhesive. Each layer of adhesive had a thickness of 30-40 um.

### Evaluation

Light leakage was evaluated by exposing Example 1 and Comparative Example 1 to light flux and heat typically experienced in front screen HTPS projectors. Each sample was placed in an Epson 81 P Projector with the imager removed, and the green channel was used for measurement. The polarizer was aligned such that light was absorbed and a dark state was produced on a screen. The light intensity was then measured at the four corners of the screen (at 90% field point), and in the center, using a Minolta CL 200 Lux Meter and a 0.4 neutral density filter. By comparing the center and corner lux values, the relative light leakage between samples can be measured.

The samples were oriented two ways in the test, and the respective orientations are shown schematically in FIGS. 7A and 7B. In each case the test fixture included a lamp 702 and illumination optics 704, as well as an X-cube/projection lens 706 and the detector 708. The imager 710, which is shown in phantom in FIGS. 7A and 7B, was not present during the test, but is included in the drawings to show the orientation of the polarizer constructions with respect to the other optical components in the test fixture. Orientation 1, which is shown in FIG. 7A, simulated an application in which the polarizer construction 712 in the test fixture 700 is used in the entrance position. In this case, the quartz substrate 714 was positioned towards the lamp 702, and the polarizer 716 was positioned toward the X-cube/projection lens 706. Orientation 2, which is shown in FIG. 7B, simulated an application in which the polarizer construction 722 in the test fixture 800 is used in the exit position. In orientation 2 the quartz substrate 724 faces away from the lamp 702, and the polarizer 726 faces away from the X-cube/projection lens 706.

To perform the test, the polarizer constructions 712, 722 were inserted in the test fixture 700/800 and allowed to stabilize in temperature for at least two minutes. Light flux was measured previously for the same projector in green (500-600 nm). With the use of the neutral density (ND) filter (a filter with a low transmission and uniform spectral response) and projection lens the light flux was calculated to be at least 12 mW/mm². Results are shown in Table 2.

TABLE 2

| | | | | Calculation | |
|---|---|---|---|---|---|
| | | Measured Lux | | Corner | Center |
| | | | 4 | Leakage - | Leakage |
| | | | Corner | Change from | Compared |
| Sample | Orientation | Center | Average | Center | to Ex. 1 |
| Comparative | 1 | 0.5 | 1.4 | 1.0 | 0.2 |
| Example 1 | | | | | |
| Comparative | 2 | 1.0 | 1.9 | 0.9 | 0.7 |
| Example 1 | | | | | |
| Example 1 | N/A | 0.3 | 1.1 | 0.8 | N/A |

The data in Table 2 show that, in both orientations 1 (FIG. 7A) and 2 (FIG. 7B), Comparative Example 1 shows more light leakage than Example 1, in the comparison of each of the center values. While the magnitude of the change is fairly small in the corner leakage data, it is important to note the overall increase in light level with Comparative Example 1. In both orientations and all locations (center and the corner), the total light level was higher for Comparative Example 1 as compared to Example 1. This is more evident in orientation 2.

Visually, there was noticeable leakage for both Example 1 and Comparative Example 1. For Example 1 and Comparative Example 1 in orientation 1, the leakage pattern was typical of a cross polarizer leakage pattern while Comparative Example 1 in orientation 2 showed the cross polarizer leakage pattern as well as more bright regions closer in from the corners than the set measurement location (one location measured 6.9 lux). For orientation 2, it is likely that the high light leakage originates from the cellulose triacetate structure and both its inherent birefringence and induced birefringence.

### Example B

Support Layer Material 1 was poured into a mold with a disk-shaped cavity 47 mm in diameter and approximately 4.5 mm in thickness. The disk was heated to 80° C. and exposed for 60 s under a Norlux 375 nm LED array to cure the material. Comparative commercially-available materials were formulated with 0.06 wt. % Lucirin TPO-L and analogously cured into disks. The transmittance (% T) at 420 nm and b* values were measured on these disks using a TCS Plus Spectrophotometer (BYK-Gardner USA, Silver Spring, Mo.). The results are shown in Table 3.

The cured disk samples were mounted on a rotating stage, and the transmission spectral ellipsometry (TSE) retardance date was measured at a series of positions using a J. A. Woollam M2000 Variable Angle Spectral Ellipsometer. In-plane measurements were taken at 4 locations 6 millimeters apart in two orthogonal directions, for a total of 8 in-plane measurements. The measured retardances were averaged in the wavelength range between 545-555 nanometers. The birefringence of the sample was determined by dividing the retardance by sample thickness. The birefringence values are shown in Table 3.

A portion of the disks was cut with a diamond saw into beams with nominal dimensions of 1 mm by 4.5 mm by 20 mm for dynamic mechanical analysis testing. These beams were then tested with a Thermal Analysis Q800 DMA instrument in a single cantilever bend mode with a span of 4.5 mm, a frequency of 1 Hz, and an amplitude fixed at 5 microns. The temperature was ramped at a rate of 2° C./min from 25° C. to 150° C. The maximum tan delta value observed in the DMA experiment was used to determine the T_{g}. These modulus and T_{g} results are shown in Table 3.

A portion of the disks was also cut with a diamond saw into beams with nominal dimensions of 9 mm by 4.5 mm with a length between 37 and 47 mm. The fracture toughness of these beams was measured using single-edge-notched beam fracture tests based on ASTM D 5045-99. The beams were notched on one side using a diamond saw to produce single-edge-notched beam specimens. A crack was introduced in each specimen by tapping a razor blade in the notch. The specimens were then tested to failure with a Sintech/MTS load frame with support rollers spaced 36 mm apart in the configuration described in the standard. The test temperature was 22° C., and the loading rate was 10 mm/min. In all cases, the load displacement curve showed linear elastic loading followed by catastrophic fast fracture. The stress intensity factor (K_{Ic}) was then calculated as described in the standard, and the results are shown in Table 3.

TABLE 3

| | | Modulus | | K_{1c} | | | |
|---|---|---|---|---|---|---|---|
| | | at 110° C. | Tg | (MPa) | | % T at | |
| Example | Material | (MPa) | (° C.) | (m^{1/2}) | b* | 420 nm | Birefringence |
| Ex. 2 | Support | 58 | 106 | 0.45 | 0.99 | 89.8 | 1.72 × 10⁻⁷ |
| | Layer | | | | | | |
| | Material 1 | | | | | | |
| Comp. | EBECRYL | 240 | 112 | 0.57 | 1.6 | 85.0 | 7.06 × 10⁻⁵ |
| Ex. 2 | 600 | | | | | | |
| Comp. | EBECRYL | 756 | 92 | 0.48 | 1.2 | 88.5 | 7.81 × 10⁻⁶ |
| Ex. 3 | 830 | | | | | | |
| Comp. | CN 1963 | 137 | 118 | 1.06 | 1.7 | 87.4 | 3.88 × 10⁻⁶ |
| Ex. 4 | | | | | | | |

### Example C

Support Layer Material 2 was prepared as follows. A solution of IBOA (350 g), HBA (40 g), IOTG (12 g), VAZO 52 (0.02 g), VAZO 88 (0.02 g) and LUPERSOL 130 (0.02 g) was heated under nitrogen with stirring until it exothermed to over 180° C. It was allowed to cool to 180° C. and 10 g of IBOA with an additional 0.02 g of VAZO 88 were added. The stirring at 180° C. under N₂ was continued for 40 min. The flask was then flushed with air. The temperature of the solution was reduced to 120° C. MAnh (45.6 g) and IRGANOX 1076 (0.8 g) were added, and the reaction was stirred for four hours. After cooling, 5.9 g of this resin was mixed with HDDMA (0.74 g), BISOMER EP100 DMA (0.74 g), and VAZO 67 (0.022 g).

Plates of 1 mm thick float glass (borosilicate glass) were cut to 25 mm squares. These were dipped in a solution of 5 wt % water, 2 wt % 3-(methacryloyloxy)propyltrimethoxysilane, and 0.5 wt % acetic acid in isopropanol. They were rinsed with isopropanol and then dried in an oven at 140° C. for 25 min. KE-type polarizer film pieces of dimensions 17.4 mm×20.2 mm were dipped in the same silane solution for 10 s each, and then rinsed with isopropanol. These were then placed in a 100° C. oven for 1 h.

Several drops (0.15-0.4 g) of Support Layer Material 2 were placed on the top surface of the silane-treated glass substrate described above. A silane-treated polarizer film of dimensions 17.4 mm×20.2 mm was placed onto this uncured liquid support layer. Several more drops (0.15-0.4 g) of Support Layer Material 2 were placed on the polarizer. A second silane-treated glass substrate was placed on top of this stack and pressed down to squeeze out excess liquid. This sandwich assembly was placed in an 80° C. oven for 16 hours. It was then put in a 120° C. oven for an additional 80 minutes. Upon removing, the liquid had cured into a firm polymer. Excess polymer was removed with a razor blade and the glass surfaces of the encapsulated polarizer were cleaned with acetone.

### Example D

Constructions described in FIG. 4A were compared to the construction shown in FIG. 1 in a comparative study of substrate configurations exposed to 22 mW/mm² light flux of random polarization and of spectral content between 500 nm and 580 nm. The comparison consisted of using KE polarizer in FIG. 4A construction using single crystal quartz as both substrate materials and fused silica as both substrate materials.

Alternately, KE polarizer was adhered to TAC using a UV adhesive (as described in US 2006/0139574 A1). This construction was adhered to substrate materials consisting of single crystal quartz, sapphire, and fused silica. During exposure, the surface temperature was measured with a Raytheon IR imaging camera. Comparing the surface temperatures between the FIG. 4A construction with the standard construction shows lower surface temperature with the FIG. 4A construction compared to the FIG. 1 construction. Results are shown in Table 4.

TABLE 4

| | | Surface |
|---|---|---|
| | | Temperature |
| Example | Structure | (° C.) |
| Ex. 3 | KE/TAC on 1.4 mm thick single | 41 |
| | crystal quartz (FIG. 4A | |
| | construction) | |
| Ex. 4 | KE/TAC on 0.5 mm thick on | 36 |
| | sapphire (FIG. 4A construction) | |
| Ex. 5 | KE “sandwich” with 0.7 mm single | 31 |
| | crystal quartz (FIG. 4A | |
| | construction) | |
| Comparative | KE/TAC on 0.7 mm fused silica | 71 |
| Example 6 | (FIG. 1 construction) | |
| Comparative | KE “sandwich: with 0.7 mm single | 64 |
| Example 7 | crystal quartz (FIG. 1 construction) | |

TAC = cellulose triacetate

### Example E

Polarizer constructions described in FIG. 4A (prepared according to the procedures in Example 1) were prepared in a study comparing surface preparation method of KE polarizer film material to minimize yellowing under environmental tests (environmental oven set at 100° C.). In addition to adding the silane treatment prior to assembly of the construction, the KE polarizer was dried at 100° C. for 1 hour and at 120° C. for 1 hour. The results show that after 240 hours of enviromental aging in the oven, the sample that was dried at 120° C. for 1 hour prior to assembly had a smaller transmission loss than the sample dried at 100° C. for 1 hour prior to assembly. The average change in transmission over the wavelength range 500 nm-590 nm for the 100° C. dried sample was 1.48% compared to 0.67% for the 120° C. dried sample. The drying of the KE polarizer prior to assembly minimizes any additional catalyzed dehydration that can occur when the KE polarizer is subjected to high temperatures. Results are shown in Table 5.

TABLE 5

| | | Change in % T After |
|---|---|---|
| Example | Surface Preparation Method | 240 hours at 100° C. |
| Ex. 6 | KE polarizer dried at 120° C. for 1 | 0.67 |
| | hour prior to assembly | |
| Ex. 7 | KE polarizer dried at 100° C. for 1 | 1.48 |
| | hour prior to assembly | |

Various embodiments of the invention have been described. These and other embodiments are within the scope of the following claims.

What is claimed is:

1. An optical element comprising an intrinsic polarizer having thereon a support layer, the support layer comprising a reaction product of:
(a) from 50 to 99 parts by weight of a (meth)acryloyl oligomer having a plurality of pendant, free radically polymerizable functional groups and a Tg of greater than or equal to 20° C.,
(b) from 1 to 50 parts by weight of a free-radically polymerizable crosslinking agent and/or diluent monomer, and
(c) from 0.001 to 5 parts by weight of an initiator.

2. The optical element of claim 1, the intrinsic polarizer comprising a KE-type polarizer or a K-type polarizer.

3. The optical element of claim 1, the support layer comprising a reaction product of:
(a) from 75 to 85 parts by weight of a (meth)acryloyl oligomer having a plurality of pendant, free radically polymerizable functional groups and a Tg of greater than or equal to 20° C.,
(b) from 15 to 25 parts by weight of a free-radically polymerizable crosslinking agent and/or diluent monomer, and
(c) from 0.001 to 5 parts by weight of an initiator.

4. The optical element of claim 1, the (meth)acryloyl oligomer comprising the reaction product of:
(a) from 50 to 99 parts by weight of (meth)acrylate ester monomer units homopolymerizable to a polymer having a Tg of greater than or equal to 20° C.,
(b) from 1 to 50 parts by weight of monomer units having a pendent, free-radically polymerizable functional group, and
(c) less than 40 parts by weight of monomer units homopolymerizable to a polymer having a glass transition temperature of less than 20° C., based on 100 parts by weight of a) and b).

5. The optical element of claim 4, wherein the (meth)acrylate ester monomer units are homopolymerizable to a polymer having a Tg of greater than or equal to 50° C.

6. The optical element of claim 1, wherein the initiator is a photoinitiator.

7. The optical element of claim 1, the support layer comprising a first support layer, and the optical element further comprising a second support layer, wherein the polarizer is disposed between the first and second support layers.

8. The optical element of claim 1, wherein the polarizer is encapsulated in the support layer.

9. The optical element of claim 1, wherein the support layer has a thickness of less than or equal to 0.5 mm.

10. The optical element of claim 1, further comprising an optically clear substrate adjacent the support layer and opposite the polarizer.

11. The optical element of claim 10, wherein the substrate is glass or a polymer.

12. The optical element of claim 10, wherein the substrate is glass selected from the group consisting of quartz, sapphire and borosilicate.

13. The optical element of claim 1, wherein the polarizer comprises a silane surface treatment.

14. The optical element of claim 10, wherein the substrate is a glass having a silane surface treatment.

15. The optical element of claim 10, further comprising an antireflective layer on the substrate.

16. The optical element of claim 10, further comprising an adhesive layer disposed between the support layer and the substrate.

17. The optical element of claim 1, the support layer having a Tg of greater than 50° C. and a modulus of elasticity of at least 50 MPa at a temperature of 110° C.

18. An optical element comprising:
an intrinsic polarizer having opposing first and second major surfaces;
a first support layer on the first major surface of the intrinsic polarizer, the first support layer comprising a reaction product of:
(a) from 50 to 99 parts by weight of a (meth)acryloyl oligomer having a plurality of pendant, free radically polymerizable functional groups and a Tg of greater than or equal to 20° C.,
(b) from 1 to 50 parts by weight of a free-radically polymerizable crosslinking agent and/or diluent monomer, and
(c) from 0.001 to 5 parts by weight of an initiator;
a first optically clear substrate on the first support layer opposite the intrinsic polarizer;
a second support layer on the second major surface of the intrinsic polarizer, the second support layer comprising a reaction product of:
(a) from 50 to 99 parts by weight of a (meth)acryloyl oligomer having a plurality of pendant, free radically polymerizable functional groups and a Tg of greater than or equal to 20° C.,
(b) from 1 to 50 parts by weight of a free-radically polymerizable crosslinking agent and/or diluent monomer, and
(c) from 0.001 to 5 parts by weight of an initiator; and
a second optically clear substrate on the second support layer opposite the intrinsic polarizer.

19. The optical element of claim 18, having a thickness of less than or equal to 1.5 mm.

20. An optical element comprising:
a support layer comprising a reaction product of:
(a) from 50 to 99 parts by weight of a (meth)acryloyl oligomer having a plurality of pendant, free radically polymerizable functional groups and a Tg of greater than or equal to 20° C.,
(b) from 1 to 50 parts by weight of a free-radically polymerizable crosslinking agent and/or diluent monomer, and
(c) from 0.001 to 5 parts by weight of an initiator;
an intrinsic polarizer encapsulated in the support layer; and
first and second optically clear substrates disposed on opposing outer surfaces of the support layer.

21. The optical element of claim 20, having a thickness of less than or equal to 1.5 mm.

22. A method of forming an optical element, comprising:
(A) providing an intrinsic polarizer with a first major surface and a second major surface;
(B) applying to at least one of the first and second major surfaces a layer of a curable composition comprising:
(a) from 50 to 99 parts by weight of a (meth)acryloyl oligomer having a plurality of pendant, free radically polymerizable functional groups and a Tg of greater than or equal to 20° C.,
(b) from 1 to 50 parts by weight of a free-radically polymerizable crosslinking agent and/or diluent monomer, and
(c) from 0.001 to 5 parts by weight of an initiator; and
(C) curing the layer of the curable composition with UV light to form a cured support layer.

23. A projector system comprising a light source and the optical element of claim 1.

24. The projector system of claim 23, wherein the optical element further comprises a LCD panel.
